(19) United States
(12) Patent Application Publication
(10) Pub. No.: US 2011/0181201 A1
(43) Pub. Date: Jul. 28, 2011

(54) LED Display System and Method for Use with an Audio System

(76) Inventor: Dale Hollis, Manchester, NH (US)

(21) Appl. No.: 12/938,828

(22) Filed: Nov. 3, 2010

Related U.S. Application Data
(60) Provisional application No. 61/298,758, filed on Jan. 27, 2010.

(51) Int. Cl. H05B 37/02

(52) U.S. Cl. 315/294

(57) ABSTRACT

The light-emitting diode (LED) display system and method are provided. A LED display structure houses a quantity of LEDs. A control unit is in communication with the LED display structure. An audio output system supplies at least one audio signal to the control unit, wherein the control unit processes the at least one audio signal and transmits at least one processed audio signal to the LED display structure. A quantity of light is emitted from at least a portion of the quantity of LEDs is based on the at least one processed audio signal. A selection device is in communication with the control unit and controlling selection of at least one display mode of the LED display structure. At least one power supply supplies a quantity of voltage to at least one of the LED display structure, the audio output system, the control unit and the selection device.

### CROSS REFERENCE TO RELATED APPLICATION

This application claims benefit of copending U.S. Provisional Application entitled, “LED Display System and Method for Use with an Audio System,” having Ser. No. 61/298,758 filed Jan. 27, 2010, the entire disclosure of which is incorporated herein by reference.

### FIELD OF THE DISCLOSURE

The present disclosure is generally related to LED display systems and more particularly is related to an LED display system and method for use with an audio system.

### BACKGROUND OF THE DISCLOSURE

Light-emitting diodes (LED) are a light source created from a semiconductor. Uses for LEDs are varied and numerous and may commonly include uses within indicator lamps in a vehicle, or uses within electronic signs. LEDs generally emit low-intensity red, green and blue colored lights with varying brightness. LEDs have a compact size, which allows them to be useful in advanced technologies, such as devices within the communication, entertainment and commercial industries. However, LEDs are not used to their full potential within some of these industries, which may result in unneeded power consumption or an unrefined lighting system. In addition, LEDs may be incorporated into existing technologies to decrease the energy usage that is commonly associated with incandescent light bulbs.

Thus, a heretofore unaddressed need exists in the industry to address the aforementioned deficiencies and inadequacies.

### SUMMARY OF THE DISCLOSURE

Embodiments of the present disclosure provide a LED display system and method for use with an audio system. Briefly described, in architecture, one embodiment of the system, among others, can be implemented as follows. The system contains a LED display structure housing a quantity of LEDs. A control unit is in communication with the LED display structure. An audio output system supplies at least one audio signal to the control unit, wherein the control unit processes the at least one audio signal and transmits at least one processed audio signal to the LED display structure. A quantity of light is emitted from at least a portion of the quantity of LEDs based on the at least one processed audio signal. A selection device is in communication with the control unit and controlling selection of at least one display mode of the LED display structure. At least one power supply supplies a quantity of voltage to at least one of the LED display structure, the audio output system, the control unit and the selection device.

The present disclosure can also be viewed as providing a method of displaying LEDs for use with an audio system. In this regard, one embodiment of such a method, among others, can be broadly summarized by the following steps: housing a quantity of LEDs in an LED display structure; connecting a control unit in communication with the LED display structure; supplying the control unit with at least one audio signal from an audio output system; processing the at least one audio signal into at least one processed audio signal; transmitting the at least one processed audio signal to the LED display structure; controlling a quantity of light emitted from at least a portion of the quantity of LEDs with the at least one processed audio signal; selecting at least one display mode of the LED display structure; and supplying a quantity of voltage to at least one of the LED display structure, the audio output system and the control unit with at least one power supply.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration of a perspective view of a LED display system for use with an audio system, in accordance with a first exemplary embodiment of the present disclosure.

FIG. 2 is an illustration of a perspective view of a LED display system for use with an audio system, in accordance with a second exemplary embodiment of the present disclosure.

FIG. 3 is a flowchart illustrating a method of displaying LEDs for use with an audio system shown in FIG. 1, in accordance with the first exemplary embodiment of the present disclosure.

### DETAILED DESCRIPTION

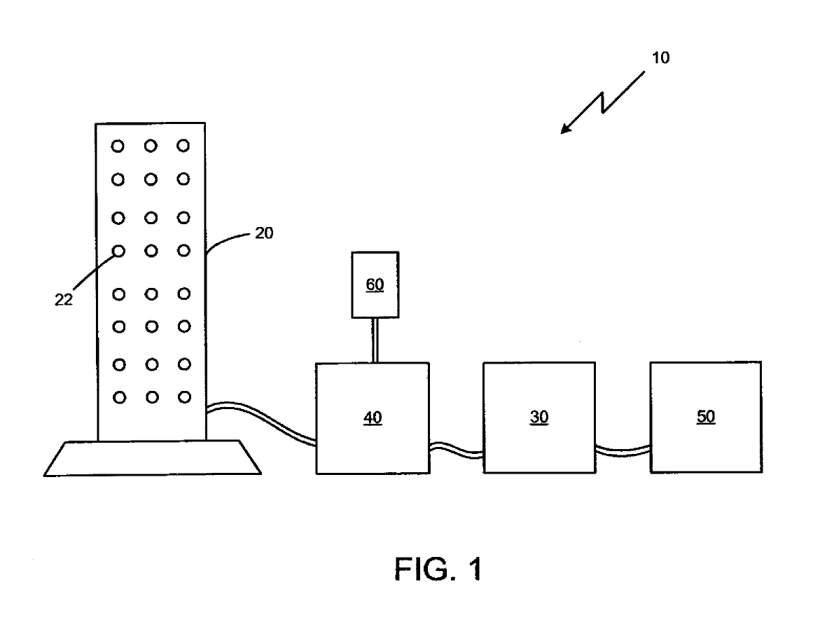

FIG. 1 is an illustration of a perspective view of a LED display system 10 for use with an audio system, in accordance with a first exemplary embodiment of the present disclosure. The LED display system for use with an audio system includes a LED display structure 20 housing a quantity of LEDs 22. A control unit 40 is in communication with the LED display structure 20. An audio output system 30 supplies at least one audio signal to the control unit 40. The control unit 40 processes the audio signal and transmits at least one processed signal to the LED display structure 20. A quantity of light emitted from at least a portion of the quantity of LEDs 22 is based on the processed audio signal. A selection device 60 is in communication with the control unit 40 and situated to allow selection of at least one display mode of the LED display structure 20. At least one power supply 50 supplies a quantity of voltage to any one, or any combination of the LED display structure 20, the audio output system 30 and the control unit 40.

The LED display structure 20 may include a variety of structures, including a rigid structure, a flexible structure, an elongated or shortened structure, or any combination thereof. For example, commonly the LED display structure 20 may be an elongated tubular structure having diameter and an outer circumference with a plurality of LEDs 22 affixed thereto. With any design of the LED display structure 20, the plurality of LEDs 22 may be located within the display structure 20. The LED display structure 20 may include an outer surface that is at least partially translucent, thereby making the light emitted from the plurality of LEDs 22 visible. The LED display structure 20 may also include a base (as illustrated in FIG. 1) or holding structure, such as a fastening mechanism having a screw or fastening device.

LED circuits may be included to facilitate activation of the plurality of LEDs 22. The LED circuits may be located within the LED display structure 20, such as when the LED display structure 20 is large and rigid, or external to the LED display structure 20, such as when the LED display structure 20 is constructed from a flexible material. The plurality of LEDs 22 may include any number, type, size or color of light-emitting diodes, such as a combination of red, green and blue colors housed within one package. All variations, designs and configurations of the LED display structure 20 and the plurality of LEDs 22 is considered within the scope of the present disclosure.

The control unit 40 may be in communication with the LED display structure 20 and the audio output system 30 by any communication connection, including wired and wireless connections. The control unit 40 may receive at least one audio signal from audio output system 30 and process the audio signal. The control unit 40 may process the audio signal into a processed audio signal, which is transmitted to the LED display structure 20. Processing the audio signal into the processed audio signal may include a variety of techniques and processes, including converting the audio signal into a quantity of digital data, compressing the audio signal, converting the audio signal to an alternative format, and any other type of processing. Any conversion, change or alteration is considered within the scope of the present disclosure. In addition, processing the audio signal may include simply retransmitting the received audio signal to the LED display structure 20 with minimal or no changes.

The control unit 40 may include any type of device or system capable of processing an audio signal. For example, the control unit 40 may be a computerized device having a program that converts the audio signal received from the audio output system 30 into a light-controlling signal, capable of controlling the plurality of LEDs 22. The audio output system 30 may be any device capable of outputting an audio signal. Commonly, the audio output system 30 may include an audio amplifier having at least one output terminal. An audio amplifier within the audio output system 30 may be located within a variety of audio devices, such as car audio systems, DJ equipment, band equipment, Mp3 players, home audio equipment, commercial audio devices and other audio output devices would be enhanced when used with the system 10.

The quantity of light emitted from at least a portion of the quantity of LEDs 22 is based on the processed signal transmitted from the control unit 40 to the LED display structure 20. For example, the control unit 40 may transmit a processed signal controlling plurality of LEDs 22 such that only a portion light up when a particular processed audio signal is received. As one having ordinary skill in the art would recognize, this may be accomplished through computerized and non-computerized devices. For example, the control unit 40 may employ a computerized program that controls the quantity of LEDs 22, enabling a variety of visual effects to be created from lighting the LEDs 22 when audio signals are received.

A selection device 60 may be in communication with the control unit 40. The selection device 60 may allow selection of at least one display mode of the LED display structure 20. Generally, the display mode may correspond to a quantity of light emitted from a specified portion of the quantity of LEDs 22. The control unit 40 may control a direction, a color, a speed and a configuration associated with the quantity of light emitted. For example, the control unit 40 may direct a particular row of the quantity of LEDs 22 to be lit, or a single LED to be lit. As one having ordinary skill in the art would recognize, there are many variations on which LEDs of the quantity of LEDs 22 may be lit, all of which are considered within the scope of the present invention. The control unit 40 or any other component of the system 10 may include a computer-readable program stored on a computerized database, such as software.

The LED display structure 20, quantity of LEDs 22, the audio output system 30 and the control unit 40, or any combination thereof, may be powered with the power supply 50. The power supply 50 may include any power supply device, such as an outlet, a battery or combination thereof. Any number of power supplies 50 may be included, such as one power supply 50 that supplies power to all of the components of the system 10, many power supplies 50 supplying power to each component individually, or any other number of power supplies 50 supplying power to the components of the system 10 in any configuration. For example, one power supply 50 may be included to supply power to the control unit 40 and quantity of LEDs 22, with a second power supply 50 to supply power to the audio output system 30.

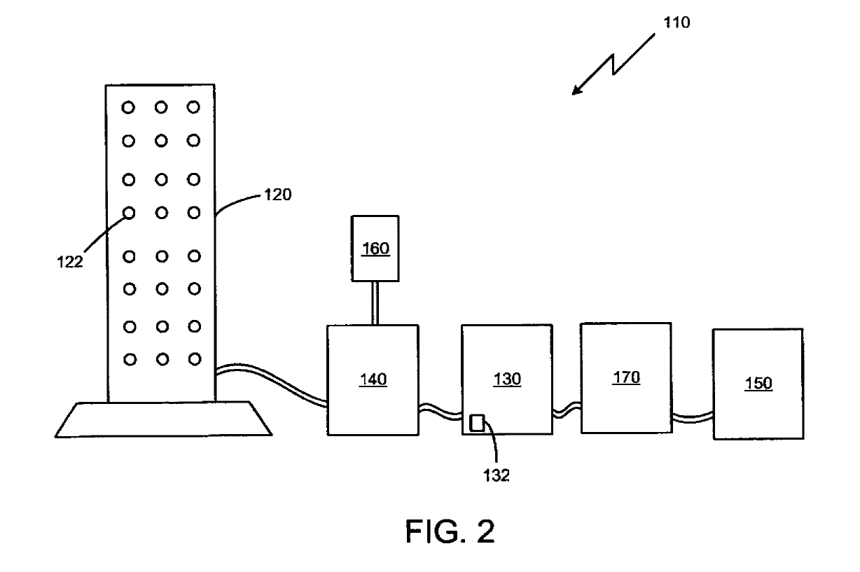

FIG. 2 is an illustration of a perspective view of a LED display system 110 for use with an audio system, in accordance with a second exemplary embodiment of the present disclosure. The LED display system 110 of the second exemplary embodiment may be similar to the system 10 of the first embodiment with the inclusion of additional components. Accordingly, any of the features, components and/or characteristics of the first exemplary embodiment are considered within the scope of the second exemplary embodiment. The system 110 includes a LED display structure 120 housing a quantity of LEDs 122. An audio output system 130 supplies at least one audio signal to a control unit 140, in communication with the LED display structure 120. The control unit 140 processes the audio signal into a processed audio signal and transmits the processed audio signal to the LED display structure 120. The control unit 140 controls a quantity of light emitted from at least a portion of the quantity of LEDs 122 based on the processed audio signal. A power supply 150 supplies a quantity of voltage to any one, or any combination of the LED display structure 120, the audio output system 130 and the control unit 140.

A selection device 160 may be in communication with the control unit 140. The selection device 160 may allow selection of at least one display mode of the LED display structure 120. Generally, the display mode may correspond to a quantity of light emitted from a specified portion of the quantity of LEDs 122. The control unit 140 may control a direction, a color, a speed and a configuration associated with the quantity of light emitted. For example, the control unit 140 may direct a particular row of the quantity of LEDs 122 to be lit, or a single LED to be lit. As one having ordinary skill in the art would recognize, there are many variations on which LEDs of the quantity of LEDs 122 may be lit, all of which are considered within the scope of the present invention. The control unit 140 or any other component of the system 110 may include a computer-readable program stored on a computerized database, such as software.

The system 110 may include one or more outputs 132 on the audio output system 130. FIG. 2 depicts the system 110 with one output 132. The output 132 may include a pre-amp output, a speaker output, or any other output known to those having ordinary skill in the art. If the output 132 is a pre-amp output, the audio signal may be supplied to the control unit 140 and transmitted to the LED display structure 120 with a direct connection. If the output 132 is a speaker output, the audio signal may be supplied to the control unit 140, and transmitted to the LED display structure 120 with a parallel connection. A variety of connections may be included, as would vary with the design of the system 110, all of which are considered within the scope of the present disclosure.

A power-controlling unit 170 may be included in the system 110 to receive the audio signal from the audio output system 130 and managing a power level of the audio signal. The power-controlling unit 170 may manage the power level of the audio signal to be less than five volts or amplify the power level of the audio-signal when the power level is at a low voltage. Additionally, the power-controlling unit 170 may manage the power level of the audio signal to be less than or greater than five volts, which includes any voltage level, or amplify the power level of the audio signal to any value. The control unit may also convert the supplied audio signal into a quantity of digital data. In addition, a RGB circuit or plurality of circuits (not shown) may be included in the system 110 in communication with the control unit 140. The RGB circuitry may, alone or in combination with the control unit 140, control at least a portion of the quantity of LEDs 122, such as by controlling a particular color of LED or number of LEDs to be activated.

The system 110 may include the various components in any configuration, as may be determined by design. For example, each individual component may be housed separately and connected via various connections, such as wired or wireless connections. Additionally, any of the audio output system 130, the control unit 140 and the selection device 160 are integrally housed in the LED display structure 120. The LED display structure 120 may be a stand-alone structure that is independent of any other device. Furthermore the LED display structure 120, having any of the other components included integrally therein, may be a substantially stand alone structure. A stand alone structure may be a structure that is operated remote from other devices. For example, the LED display structure may be mounted to a wall or ceiling in a position that is remote from musical equipment, or other optical equipment.

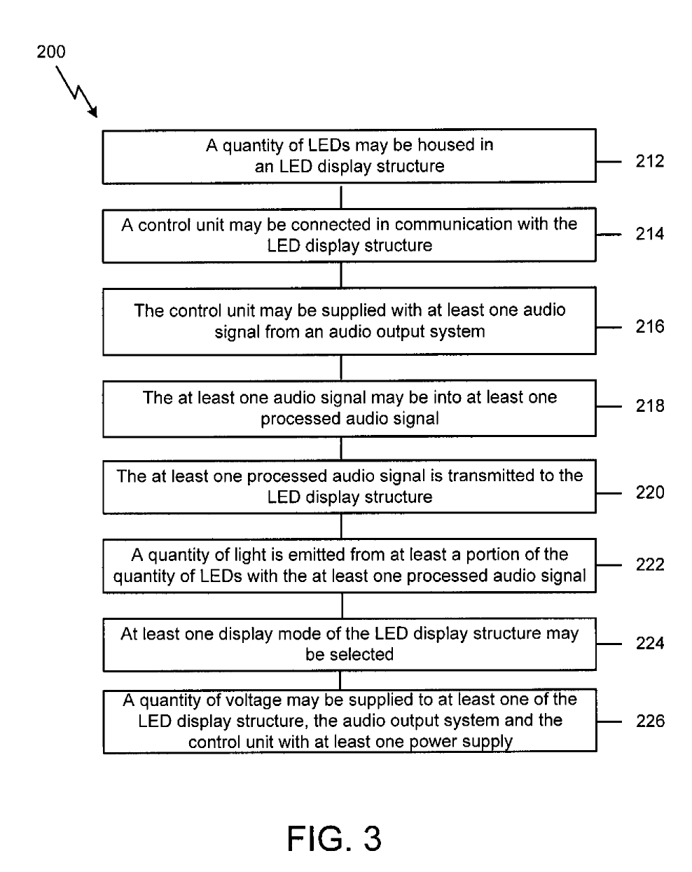

FIG. 3 is a flowchart 200 illustrating a method of displaying LEDs for use with an audio system shown in FIG. 1, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 212, a quantity of LEDs may be housed in an LED display structure. A control unit may be connected in communication with the LED display structure (block 214). The control unit may be supplied with at least one audio signal from an audio output system (block 216). The at least one audio signal may be into at least one processed audio signal (block 218). The at least one processed audio signal is transmitted to the LED display structure (block 220). A quantity of light is emitted from at least a portion of the quantity of LEDs with the at least one processed audio signal (block 222). At least one display mode of the LED display structure may be selected (block 224). A quantity of voltage may be supplied to at least one of the LED display structure, the audio output system and the control unit with at least one power supply (block 226). Additional steps may also be optionally included, depending on the design chosen. For example, the display mode selected may correspond to a quantity of light emitted from a specified portion of the quantity of LEDs. A power level of the audio signal may be managed with a power-controlling unit receiving the audio signal from the audio output system.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. A light-emitting diode (LED) display system for use with an audio system, the LED display system comprising:
a LED display structure housing a quantity of LEDs;
a control unit in communication with the LED display structure;
an audio output system supplying at least one audio signal to the control unit, wherein the control unit processes the at least one audio signal and transmits at least one processed audio signal to the LED display structure, wherein a quantity of light emitted from at least a portion of the quantity of LEDs is based on the at least one processed audio signal;
a selection device in communication with the control unit and controlling selection of at least one display mode of the LED display structure; and
at least one power supply, supplying a quantity of voltage to at least one of the LED display structure, the audio output system, the control unit and the selection device.

2. The LED display system of claim 1, wherein the at least one display mode corresponds to a quantity of light emitted from a specified portion of the quantity of LEDs.

3. The LED display system of claim 1, wherein the audio output system further comprises a pre-amp output supplying the at least one processed audio signal to the LED display structure with a direct connection.

4. The LED display system of claim 1, wherein the audio output system further comprises a speaker output, wherein the at least one processed audio signal is supplied to the LED display structure with a parallel connection.

5. The LED display system of claim 1, further comprising a power-controlling unit, receiving at least a portion of the audio signal from the audio output system, wherein the power-controlling unit manages a power level of the audio signal.

6. The LED display system of claim 5, wherein the power-controlling unit manages the power level of the audio signal to be less than five volts.

7. The LED display system of claim 5, wherein the power-controlling unit amplifies the power level of the audio signal when the power level is at a low voltage.

8. The LED display system of claim 1, wherein the control unit processes the at least one audio signal by converting the at least one audio signal into a quantity of digital data.

9. The LED display system of claim 1, wherein the control unit further comprises a computer-readable program stored on a computerized database.

10. The LED display system of claim 1, wherein the control unit controls at least one of a direction, a color, a speed and a configuration of the quantity of light emitted.

11. The LED display system of claim 1, wherein the audio output system, the control unit and the selection device are integrally housed in the LED display structure, wherein the LED display structure is a substantially stand alone structure.

12. A method of displaying light-emitting diodes (LEDs) for use with an audio system, the method comprising:
housing a quantity of LEDs in an LED display structure;
connecting a control unit in communication with the LED display structure;
supplying the control unit with at least one audio signal from an audio output system;
processing the at least one audio signal into at least one processed audio signal;
transmitting the at least one processed audio signal to the LED display structure;
controlling a quantity of light emitted from at least a portion of the quantity of LEDs with the at least one processed audio signal;
selecting at least one display mode of the LED display structure; and
supplying a quantity of voltage to at least one of the LED display structure, the audio output system and the control unit with at least one power supply.

13. The method of displaying LEDs for use with an audio system of claim 12, wherein the display mode corresponds to a quantity of light emitted from a specified portion of the quantity of LEDs.

14. The method of displaying LEDs for use with an audio system of claim 12, further comprising the step of managing a power level of the audio signal with a power-controlling unit receiving at least a portion of the audio signal from the audio output system.

15. The method of displaying LEDs for use with an audio system of claim 14, further comprising at least one or increasing and decreasing the power level of the audio signal with the power-controlling unit.

16. The method of displaying LEDs for use with an audio system of claim 12, wherein the step of processing the at least one audio signal further comprises converting the supplied at least one audio signal into a quantity of digital data.

17. The method of displaying LEDs for use with an audio system of claim 12, further comprising the step of controlling at least one of a direction, a color, a speed and a configuration of the quantity of light emitted

18. The method of displaying LEDs for use with an audio system of claim 12, further comprising the step of supplying the LED display structure with the at least one processed audio signal with a direct connection.

19. The method of displaying LEDs for use with an audio system of claim 12, further comprising the step of supplying the LED display structure with at least one processed audio signal with a parallel connection.

20. The method of displaying LEDs for use with an audio system of claim 12, wherein the step of controlling a quantity of light emitted from at least a portion of the quantity of LEDs from a control unit further comprises executing a computer-readable program stored on a computerized database.
